(19) United States
(12) Patent Application Publication
(10) Pub. No.: US 2023/0326274 A1
(43) Pub. Date: Oct. 12, 2023

(54) Site Access, Document Control and Notification System

(71) Applicant: Sitekee Pty Ltd., Malvern (AU)

(72) Inventors: Mario Sultana, Malvern (AU); Ross Spearritt, Malvern (AU)

(73) Assignee: Sitekee Pty Ltd., Malvern (AU)

(21) Appl. No.: 18/131,053

(22) Filed: Apr. 5, 2023

Related U.S. Application Data
(60) Provisional application No. 63/328,263, filed on Apr. 6, 2022.

(51) Int. Cl. G07C 9/27; G07C 9/28; G06Q 50/08

(52) U.S. Cl. CPC G07C 9/27; G07C 9/28; G06Q 50/08

(57) ABSTRACT

A Site Access, Document Control and Notification System is network based software accessible from any suitable mobile device that communicates with a check-in station on any limited access site and confirms that the user such as tradesman, vendors or visitors has or has not provided the site owner/manager with all the necessary permits, proofs of insurance, certificates of competence, etc. to be permitted access to the site. If the user has not provided the required documentation, the system will prompt them for the required documents which may be scanned or photographed with the user's mobile device to enable real-time confirmation and access authorization. The software system may also provide lists of required documents for each of the users that may need to be present on any jobsite and it will also remind the site owner/manager and the appropriate user when their documents are approaching expiration.

### FIELD OF THE INVENTIONS

The inventions described below relate to the field of construction site access.

### BACKGROUND OF THE INVENTIONS

Construction sites are hazardous and consequently, access to such sites is controlled to limit injuries and the liability of the site owner/manager. Contractors, tradesman and even visitors are all required to have various insurances, certificates of competence, operating licenses or other documents etc. Site owners and managers may also require additional documentation such as acknowledgement of site rules, various waivers and confirmation of site policies and acknowledgement of access to emergency services. Tracking all the necessary documentation for all the various trades, vendors and visitors that may be required on a construction site is a monumental task that often exposes the site owner/manager to unnecessary liability.

### SUMMARY

The devices and methods described below provide for a network based software accessible from any suitable mobile device that communicates with a check-in station on any limited access site and confirms that the user such as tradesman, vendors or visitors has or has not provided the site owner/manager with all the necessary permits, proofs of insurance, certificates of competence, etc. to be permitted access to the site. If the user has not provided the required documentation, the system will prompt them for the required documents which may be scanned or photographed with the user's mobile device to enable real-time confirmation and access authorization. The software system may also provide lists of required documents for each of the users that may need to be present on any jobsite and it will also remind the site owner/manager and the appropriate user when their documents are approaching expiration.

The method for access control and site document management for a jobsite includes the steps of providing a software application running on a server operatively connected to a network wherein the software application providing one or more lists of site access requirement documents to any user f view via the network, and a user providing one or more digital document files to a site manager using the software application via the network, at least one of the one or more digital document files containing an expiration date, and the site manager using the software application to verify that the one or more digital document files received from the user comply with at least one of the one or more lists of site access requirement documents and if the one or more digital document files comply with site access requirements the site manager provides an entry permit to the software that the user is cleared for access to the jobsite, and if the one or more digital document files do not comply with site access requirements denying access to the user using the software application via the network, and the software application notifying the user of a grant or denial of access to the jobsite and saving the expiration date of the at least one of the one or more digital document files and notifying the site manager and the user at a set time before the expiration date, and the software application notifying users of the jobsite of the onsite location of emergency services and other rules and requirements provided by the site manager.

### BRIEF DESCRIPTION OF THE DRAWINGS

FIG. 1 is a block diagram illustration of system for site access, document control and notification.

FIG. 2 is a flow chart of the system for site access, document control and notification illustrated in FIG. 1.

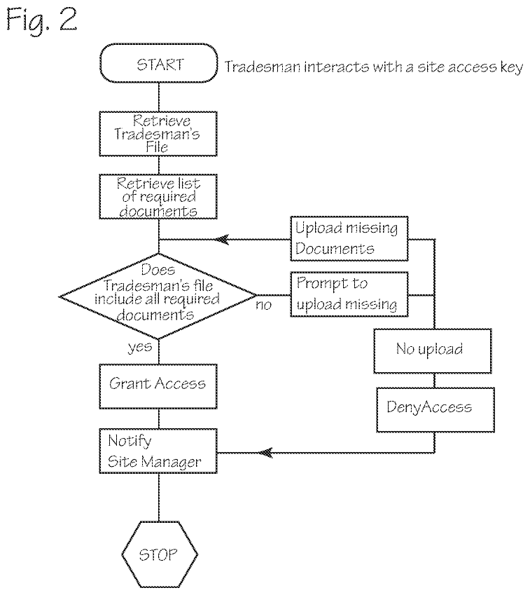

### DETAILED DESCRIPTION OF THE INVENTIONS

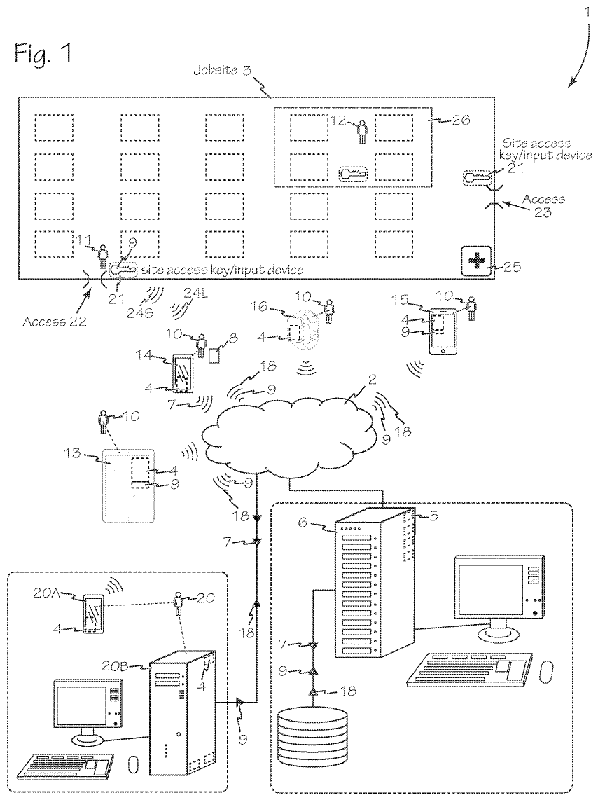

FIG. 1 is an illustration of a system 1 implementing the method and apparatus for site access, document control and notification via network 2 which may be any suitable network covering jobsite 3 such as a virtual private network, a mesh network or the world wide web. System 1 may be implemented using any suitable software such as app 4 configured to operate on any suitable mobile or desktop device as well as server software 5 on server 6. A contractor, tradesman, vendor or visitor such as users 10, 11 and 12 seeking access to a jobsite such as site 3 may use the method and apparatus for site access, document control and notification app 4 on any suitable mobile device such as iPad or tablet 13, smart phones 14 and 15 and/or smart wearable 16 to provide digital documentation 7 to the site manager 20. Digital documentation 7 is any suitable digital representation of one or more required documents, such a license 8, which may be scanned, photographed or otherwise rendered as a digital file 7 using any suitable hardware such as a computer, scanner, iPad or tablet 13, smart phones 14 and 15 and/or smart wearable 16.

System 1 for site access, document control and notification controls access to one or more physical locations such as jobsite 3 based on digital documentation 7 received, authenticated and reviewed in real time for that specific location. System 1 ensures that a site owner/manager such as site manager 20 has received the correct user documentation such as licenses, certifications and site-specific documents required by a site before site access is granted. Site manager 20 may use any suitable hardware to access app 4 such as mobile phone 20A or computer 20B. When site manager 20 confirms that a user has provided all the required documentation, such as digital documents 7, for site access, the site manager 20, via software 4, provides the user with access permission key 9.

A site access key/input device 21 can be a simple hardware component or a smart phone or other suitable mobile device, containing access permission key 9, which communicates with a tradesman's mobile device at a site access location such as locations 22 or 23. Site access data 24S from site access key/input device 21 coupled with location data 24L identifying the physical site location, triggers a documentation check to ensure system 1 has the correct documentation stored as well as access permission key 9 to permit a user, such as user 11, to be allowed on site 3.

As a user, such as user 11, is checking in at access location 22, system 1 also identifies the responsible authority, site manager 20, for this site and informs site manager 20 in real time of the access event to the site. Once access has been granted, the system also directs user 11 to the onsite emergency location 25 or to any other suitable offsite emergency services location. System 1 also provides a list of all the current contact information, jobsite contacts 18, for all relevant authorities or services for a jobsite such as the site owner, manager, site supervisor, relevant utilities, police, fire and emergency services of a jobsite to any connected user on the jobsite. System 1 ensures that all personal granted access to a site such as jobsite 3 have confirmed they are aware of the emergency and medical locations, ingress and egress locations, as well as any changes to any jobsite contacts 18, locations, rules etc. and may provide emergency notification to all users on site if an evacuation is required. System 1 also enables any network administrator, such as the site manager 20, to set reminder rates for retransmitting emergency and medical locations, ingress and egress locations, as well as any changes to any jobsite contacts 18, locations, rules etc.

In the event of an incident on the jobsite, system 1 will notify all on-site personal of the event in real-time and provide any instructions from the site manager 20. If a user, tradesman, contractor, vendor or visitor does not have the correct documentation to permit entry and work, after a set number of entry times with missing documentation, the system denies the user access to the site. The site manager may set how many times a user may be permitted access without the necessary documentation. The system also allows the site owner, if the user does not leave the site within the required timeframe, to track the user and to interact with the user and prompt them to leave the site.

The system can have different types of entry keys at any number of points across the site including at different levels of the site. Each access key/input device can be configured to have different documentation requirements before access is granted. For example, a general contractor can access Level's 1 and 2, however, to access Level 3 or high area 26, a user/contractor/tradesman may need to have the ‘Working with Heights’ state issued license and will be denied access to Level 3, high area 26, until this documentation has been received.

The system also logs all entry and exit points and allow users and site owners to retrieve the actual time on and off site using any input device.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A method for access control and site document management for a jobsite having jobsite contacts comprising the steps:
providing a software application running on a server operatively connected to a network;
the software application providing one or more lists of site access requirement documents to any user via the network;
a user providing one or more digital document files to a site manager using the software application via the network, at least one of the one or more digital document files containing an expiration date;
the site manager using the software application to verify that the one or more digital document files received from the user comply with at least one of the one or more lists of site access requirement documents and if the one or more digital document files comply with site access requirements the site manager provides an permission key through the software that the user is cleared for access to the jobsite, and if the one or more digital document files do not comply with site access requirements denying access to the user using the software application via the network;
the software application notifying the user of a grant or denial of access to the jobsite and saving the expiration date of the at least one of the one or more digital document files and notifying the site manager and the user at a set time before the expiration date; and
the software application notifying users of the jobsite of all emergency and medical locations, ingress and egress locations, as well as the jobsite contacts, locations and other rules and requirements provided by the site manager.

2. The method of claim 1 further comprising:
the site manager notifying one or more users via the software application of one or more new documents required for access to the jobsite.

3. The method of claim 1 further comprising:
the site manager using the software application to notify one or more users of the jobsite of an emergency and further notifying the users to evacuate the jobsite; and
the software application tracking the location of all users on the jobsite and notifying the site manager when all users have vacated the jobsite.

4. The method of claim 1 further comprising:
the site manager using the software application to notify one or more users of the jobsite of an approaching expiration date of one of the one or more new documents required for access to the jobsite.

5. The method of claim 1 further wherein the permission key is revoked if any of the user's one or more digital document files containing an expiration date expires.

6. The method of claim 1 wherein the step of the software application notifying users of the jobsite of the onsite location of emergency services and other rules and requirements provided by the site manager is repeated with a repetition rate set by the site manager via the software.

7. The method of claim 1 further comprising the step:
providing a list of all the current jobsite contacts to any connected user on the jobsite.

8. The method of claim 1 further comprising:
periodically transmitting to and requiring confirmation from all personal granted access to a site such as jobsite 3 awareness of all emergency and medical locations, ingress and egress locations, as well as any changes to any jobsite contacts, locations and other rules and requirements provided by the site manager.
